(19) United States
(12) Patent Application Publication
(10) Pub. No.: US 2004/0152618 A1
(43) Pub. Date: Aug. 5, 2004

(54) Particles containing fabric conditioner

(76) Inventors: Kishor Kumar Mistry, West Yorkshire (GB); Bryan David Grey, West Yorkshire (GB); Helen Marie Clare Coulter, West Yorkshire (GB); Janine Andrea Preston, West Yorkshire (GB)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/479,945

(22) PCT Filed: Jun. 6, 2002
(86) PCT No.: PCT/EP02/06209

(30) Foreign Application Priority Data
Jun. 19, 2001 (GB) 0114921.0

(51) Int. Cl. C11D 3/37

(52) U.S. Cl. 510/475

(57) ABSTRACT

A particulate composition comprising particles having a polymeric matrix including a fabric conditioning active ingredient and wherein the polymeric matrix is formed of a co-polymer of (a) an ethylenically unsaturated hydrophobic monomer with (b) a free base monomer. Preferably the composition is comprised in a detergent concentrate in which the particles are dispersed wherein the fabric conditioner is not released in the concentrate or during the wash cycle of a laundry operation but is released during the rinse cycle of said laundry operation.

This invention relates to particulate materials which contain a fabric conditioning active ingredient. The particles are designed to retain the fabric conditioner active in high electrolytic and/or surfactant environments and to release the active when exposed to more dilute aqueous environments. The compositions can be used in detergent concentrates so that fabric conditioner is only released in the rinse cycle of a laundry operation.

It is known to provide liquid fabric conditioning products for use in the rinse cycle of home laundry operations. Generally these products are applied separately from the laundry detergent product and are normally introduced into the laundry operation during one of the rinse cycles.

EP-A-398137 describes particular fabric conditioning compositions for use in the rinse cycle of home laundry operations and concerns particular cationic polyester soil release polymers that are especially effective when incorporated into such compositions as compared to corresponding nonionic or anionic soil release polymers or cellulose based cationic soil release polymers.

In addition soil release properties are generally imparted to fabrics by the use of a separate soil-release agent, usually a high molecular weight polymer, in a detergent composition or separate treatment. For example in EP-A-398133 there is disclosed a cationic polymeric soil release agent for use in a fabric conditioning composition.

EP-A-234311 describes the use of insoluble polyfunctional quaternary ammonium compounds as soil collectors, to regenerate soil-laden detergent solutions.

EP-A-309052 describes the use of quaternary ammonium salts containing at least one ester linkage as softeners in shelf-stable and biodegradable fabric softening compositions. The compositions also include a linear alkoxylated alcohol.

EP-A-506312 (Unilever) discloses the use as a soil release agent of a quaternary ammonium material comprising a compound having two C₁₂₋₁₈ alkyl or alkenyl groups connected via an ester link to a hydrocarbon chain which is connected to the quaternary nitrogen atom.

U.S. Pat. No. 4,795,032 is directed to a fabric-conditioning article for use in a washing machine having a wash, spin, and rinse cycle comprising a fabric conditioner and a water-absorbable material in a package which will permit passage of water and having at least one area which will open upon application of internal pressure for releasably containing the fabric conditioner. In use, the package is tossed into a washing machine at the beginning of the wash cycle. The package takes in or absorbs water, creating an internal pressure within the package. Upon exposure to the centrifugal force of the spin cycle, the package opens thereby releasing the conditioner into the water of the rinse cycle which activates the conditioner. Any conventional fabric conditioner, such as a fabric softener, can be utilized in conjunction with the package.

U.S. Pat. No. 4,304,562 discloses a fabric softener article added to a washer at the beginning of the wash cycle and having a delayed release, i.e., at the end of the wash cycle or the beginning of the rinse cycle. The softener containing article is a block of porous felt, cloth or foam, with fabric conditioner impregnated into an area of the block and with release being delayed until some time after the beginning of the wash cycle of the washing machine.

Introduction of fabric conditioners directly into the laundry operation generally has disadvantageous effects on the efficiency of the washing operation and also can reduce the effectiveness of the conditioner. There have been various attempts to overcome this problem.

U.S. Pat. No. 4,915,854 concerns a detergent composition which contains a conditioning agent. The objective of providing excellent fabric conditioning benefits without significantly impairing the cleaning performance of the detergent is said to have been achieved. The fabric conditioner is held in water insoluble particles comprising an amine-anionic compound ion pair complex.

Although previous attempts to provide delay release products attempt to solve this problem, there is a need to provide a more an effective fabric conditioning, especially a fabric softening product which releases the fabric conditioner only in the rinse cycle. In particular there is a need for a product which can be introduced at the beginning of the wash cycle and yet not release any of the fabric conditioner until during the rinse cycle. There is especially a need for such a product that can be introduced with the detergent formulation.

Thus in providing a delay release fabric conditioner product it is essential that the fabric conditioner is not released significantly prior to the rinse cycle since it would tend to be deterged and lost during the wash cycle without providing any positive conditioning activity on the fabric and furthermore the release of the fabric conditioner into the wash cycle may even have a deleterious effect on the efficiency detergent during the washing process. At the very least this would mean that insufficient fabric conditioner would be present to provide acceptable conditioning during the rinse cycle or even if the products compensated for this and contained more fabric conditioning active, this would be a wasteful and inefficient use of the fabric conditioning agent. On the other hand it would be possible provide a product where the fabric conditioner is locked away such that it would not be released during the wash cycle and where it is insufficiently released even in the rinse cycle. This too would lead to inefficient fabric conditioning. Thus such a delay release product should desirably not release any fabric conditioner during the wash cycle but should completely release the fabric conditioner during the rinse cycle.

Typically the detergent will be buffered to an alkaline pH, for instance around pH 9 or above. During the wash cycle the detergent would be diluted many times over (for instance 100 fold) and yet generally the pH of the wash water would still be maintained at around 9. During the rinse cycle the level of dilution normally employed would usually result in a shift in pH, typically from about 9 to about 8.5.

Thus given that the fabric conditioners are either hydrophobic compounds, such as silicones, or compounds that at least contain lipophilic moieties, it difficult to provide a product which will release the fabric conditioner satisfactorily only into the aqueous environment of the rinse cycle.

Entrapment of active ingredients can be achieved by a number of processes. Some of these techniques involve forming a polymeric shell around a central core or active ingredient. Other methods involve preparing a matrix of polymeric material throughout which an active ingredient is distributed.

Various methods for making capsules have been proposed in the literature. For instance it is known to encapsulate hydrophobic liquids by dispersing the hydrophobic liquid into an aqueous medium containing a melamine formaldehyde pre-condensate and then reducing the pH resulting in an impervious aminoplast resin shell wall surrounding the hydrophobic liquid. Variations of this type of process are described in GB-A-2073132, AU-A-27028/88 and GB-A-1507739, in which the capsules are preferably used to provide encapsulated inks for use in pressure sensitive carbonless copy paper. Generally these capsules are designed to release the core material, when the shell wall is ruptured by external forces, e.g. by compression.

Typical techniques for forming a polymer shell are described in, for instance, GB-A-1275712, GB-A-1475229, GB-A-1507739, DE-A-3545803 and U.S. Pat. No. 3,591,090.

In U.S. Pat. No. 3,838,007 droplets of enzyme dispersed in an aqueous solution of, for instance, gelatin are dispersed into water and then cross-linked, to give cross-linked particles of the gelatin containing the enzyme.

In EP-A-356240 processes for encapsulating enzyme or other biologically produced material; in a matrix of polymeric material by mixing the polymeric material with aqueous liquor containing the biologically produced material, dispersing this mixture in a water immiscible liquid and azeotroping the dispersion. The product can either be relatively coarse beads that can be recovered or a stable dispersion of small particles in the water immiscible liquid.

In EP-A-356239 there is a description of various compositions and processes primarily intended for the encapsulation of enzymes for liquid or other detergents. One type of product described therein comprises particles having a core comprising matrix polymer containing the enzyme, oil around the core and a polymer shell around the oil.

Particles of a matrix polymer containing an active ingredient can be formed as a dispersion in oil and this dispersion can then be dispersed in aqueous solution of an encapsulating polymer or blend of polymers and polymer deposition can then be caused to occur around the oil particles that contain the particles of matrix polymer that contain the active ingredient.

U.S. Pat. No. 5,744,152 describes a process for forming polymer particles introduced as a solution of a water soluble salt with a volatile amine of a polymer that is relatively insoluble and non-swelling in acid throughout which the active ingredient is dispersed or dissolved, and which the solution is heated to form the dry matrix and to volatilise the amine and thereby form a polymer that is insoluble in acid. The release of an active ingredient can be controlled by careful adjustment of the pH. This method is specifically designed for the entrapment of relatively large sized ingredients, in particular enzymes, fungi, spores, bacteria, cells or antibiotics, which are released by pH adjustment as a suitable release mechanism.

WO-A-97/24178 describes a particulate composition comprises particles having a polymeric matrix including a detergency active ingredient, wherein the polymeric matrix is formed of a free base form of a cationic polymer which is a co-polymer of an ethylenically unsaturated hydrophobic monomer with an ethylenically unsaturated substituted amine monomer. The matrix particles can be made by polymerising the free base monomer and the hydrophobic monomer while dissolved in an organic solvent so as to form a solution of the free base polymer in organic solvent. This is followed by addition of an aqueous solution of a volatile acid wherein the solvent has higher volatility than the acid. The solvent is then distilled off so as to leave a solution in water of the salt form of the polymer. A suitable volatile acid is acetic acid, in which event a suitable solvent is n-butyl acetate. The active ingredients particularly include detergent actives, including enzymes which are released during the wash cycle.

All of the aforementioned references are concerned with entrapment or encapsulation of active ingredients, which are to be released by a suitable trigger mechanism. For instance all of the aforementioned references relating to entrapment of detergent actives are designed to release their active materials during the wash cycle of the laundry operation.

An objective of the present invention is to provide polymer entrapped fabric conditioners. Specifically it would be desirable to provide a polymer entrapped fabric conditioner which only releases the fabric conditioner during the rinse cycle. In particular it would desirable to provide such products where the fabric conditioner is a cationic fabric conditioner.

Thus according to the present invention we provide a particulate composition comprising particles having a polymeric matrix including a fabric conditioning active ingredient and wherein the polymeric matrix is formed of a co-polymer of (a) an ethylenically unsaturated hydrophobic monomer with (b) a free base monomer. The free base monomer is suitably an ethylenically unsaturated monomer containing a free amine. The amine is preferably a substituted amine, preferably a monomer of the formula:

CH2═CR₁—COXR₂NR₃R₄

where R₁ is hydrogen or methyl, R₂ is alkylene containing at least two carbon atoms, X is O or NH, R₃ is a hydrocarbon group and R₄ is hydrogen or a hydrocarbon group.

The particles of the invention retain and do not release substantially any of the fabric conditioner, when placed in a high electrolytic/surfactant environment. Thus the particles will not release any of the active fabric conditioner when they are for instance dispersed in a detergent concentrate. Furthermore, we find that the fabric conditioner is not released even when dispersed in environments containing lower concentrations of electrolyte and or surfactants. Thus the fabric conditioners are surprisingly retained throughout the wash cycle of the laundry operation. However, the particles will release the fabric conditioner during the more dilute environment of the rinse cycle.

Without being limited to theory, it is believed that there may be some interaction between the fabric conditioner and the polymer which could be responsible for preventing the fabric conditioner from being released prior to the rinse cycle.

It is generally preferred that one of the hydrocarbon groups on the nitrogen atom of the free base monomer is greater than 3 carbon atoms. Thus preferably R₃ is at least 4 carbon atoms. More preferably the fabric conditioner is best retained when the R₃ is tertiary butyl and R₄ is hydrogen. However R₃ may be other butyl or higher alkyl groups or it may be other hydrocarbon groups containing at least 4 carbon atoms. R₃ can for instance be up to 30 carbon atoms or more, e.g. stearyl or lauryl. Generally effective results can be obtained using shorter alkyl groups and so R₃ is usually not more than 8 carbon atoms. The t-butyl group is also advantageous because it seems to render the monomer units containing it more resistant to alkaline hydrolysis.

R₄ is frequently hydrogen but it can be alkyl such as methyl, ethyl or higher alkyl or it can be other hydrocarbon group. The total number of carbon atoms in R₃ and R₄ together is usually below 12, often below 8.

R₂ is usually ethylene but it can be other linear or branched alkylene group containing two or more (for instance 2-4) carbon atoms.

R1 is usually methyl.

X can be NH, with the result that the cationic monomer is preferably a monoalkyl or dialkyl aminoalkyl (meth) acrylamide monomer, but preferably X is O, with the result that the cationic monomer is preferably a monoalkyl or dialkyl aminoalkyl (meth) acrylate.

We have found that polymers formed from the special combination of hydrophobic monomer that are capable of forming a homopolymer of glass transition temperature in excess of 50° C., preferably greater than 60 or 80° C. exhibit considerably improved performance in regard to the impermeability to the fabric conditioner until the particles are exposed to a suitably dilute environment. By hydrophobic monomer we mean that the monomer has a solubility in water of less than 5 g per 100 ml water at 25° C.

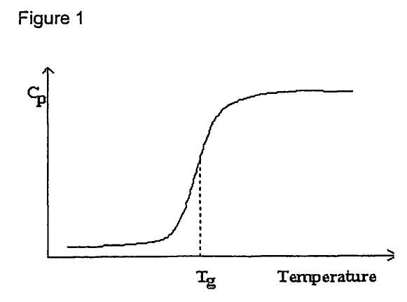

Glass transition temperature (Tg) for a polymer is defined in the Encycopedia of Chemical Technology, Volume 19, fourth edition, page 891 as the temperature below which (1) the transitional motion of entire molecules and (2) the coiling and uncoiling of 40 to 50 carbon atom segments of chains are both frozen. Thus below its Tg a polymer would not to exhibit flow or rubber elasticity. The Tg of a polymer may be determined using Differential Scanning Calorimetry (DSC). Thus a reference sample with known Tg and the experimental sample are heated separately but in parallel according to a linear temperature programme. The two heaters maintain the two samples at identical temperatures. The power supplied to the two heaters to achieve this is monitored and the difference between them plotted as a function of reference temperature which translates as a recording of the specific heat as a function of temperature. As the reference temperature is increased or decreased and the experimental sample approaches a transition the amount of heat required to maintain the temperature will be greater or lesser depending on whether the transition is endothermic or exothermic. A typical plot indicating the glass transition temperature is shown in FIG. 1.

Alternatively the hydrophobic monomer can be any ethylenically unsaturated monomer which is insoluble in water, for instance generally having a partition coefficient K between hexane and deionised water at 20° C. of at least 5 and preferably at least 10.

The hydrophobic monomer can be a water-insoluble alkyl ester of methacrylic acid or other aliphatic, water-insoluble monomer such as methyl, ethyl or butyl acrylate or methacrylate. However the preferred hydrophobic monomers are for instance ethylenically unsaturated aromatic hydrocarbon monomers, such as styrenes, preferably styrene or a methyl styrene. Thus preferably the hydrophobic monomer is selected from the group consisting of styrene, methylstyrene methyl methacrylate, acrylonitrile, tertiary butyl methacrylate, phenyl methacrylate, cyclohexyl methacrylate and isoboyl methacrylate. Most preferably the hydrophobic monomer is methyl methacrylate.

The amount of the cationic monomer which should be used will depend in part on the active ingredient which is entrapped within the monomer. The proportion of cationic free based monomer should be such that there is little or no release of the active ingredient during exposure to the wash water but that there is significant swelling and release of the active ingredient upon exposure to the rinse water.

The degrees of swelling which will result in retention or release of the active ingredient depend in part on the molecular size of the active ingredient, in that good retention of an active ingredient of small molecular size requires that the polymer should be less swollen (when exposed to the detergent concentrate or wash water) than when the active ingredient has a higher molecular size. Similarly, good release when exposed to rinse water requires a higher degree of swelling for higher molecular size active ingredients than for lower molecular size active ingredients.

Generally the amount of cationic monomer will be within the range 5-30 mole % or 10-50 weight %. When, as is preferred, the free base monomer is t-butylamino-ethyl methacrylate and the hydrophobic monomer is styrene, methyl styrene or methyl methacrylate, the amount of cationic monomer is preferably from 15%45% by weight, most preferably around 30%40% by weight.

The matrix can be formed of recurring units of monomers consisting solely of the hydrophobic monomer and the free base cationic monomer but if desired minor amounts of other monomers may be included.

The fabric conditioner may be any conventional fabric conditioner. These may be nonionic, anionic or preferably are cationic. Typically the fabric conditioner may be cationic nitrogenous compounds in the form of quaternary ammonium salts and substituted imidazolinium salts having two long chain acyclic aliphatic hydrocarbon groups for example as given in “Cationic Surface Active Agents as Fabric Softeners,” R. R. Egan, Journal of the American Oil Chemists' Society, January 1978, pages 118-121; and “How to Choose Cationics for Fabric Softeners,” J. A. Ackerman, Journal of the American Oil Chemists' Society, June 1983, pages 1166-1169. Alternatively the fabric conditioner may be quaternary ammonium salts having only one long chain acyclic aliphatic hydrocarbon group (such as monostearyltrimethyl ammonium chloride). Suitable fabric conditioners also include nonquaternary amide-amines, such as the reaction product of higher fatty acids with hydroxy alkyl alkylene diamines, for instance reaction product of higher fatty acids and hydroxyethylethylenediamine (See “Condensation Products from beta-Hydroxyethylethylenediamine and Fatty Acids or Their Alkyl Esters and Their Application as Textile Softeners in Washing Agents,” H. W. Eckert, Fette-Seifen-Anstrichmittel, September 1972, pages 527-533). These materials are usually cited generically along with other cationic quaternary ammonium salts and imidazolinium salts as softening actives in fabric softening compositions. (See U.S. Pat. No. 4,460,485, U.S. Pat. No. 4,421,792, U.S. Pat. No. 4,327,133). U.S. Pat. No. 3,775,316, discloses a softening finishing composition for washed laundry containing (a) the condensation product of hydroxyalkyl alkylpolyamine and fatty acids and (b) a quaternary ammonium compound mixture of (i) from 0% to 100% of quaternary ammonium salts having two long chain alkyl groups and (ii) from 100% to 0% of a germicidal quaternary ammonium compound. Desirably the fabric conditioners may be fabric softeners disclosed in EP 398137, U.S. Pat. No. 3,861,870, U.S. Pat. No. 4,308,151, U.S. Pat. No. 3,886,075, U.S. Pat. No. 4,233,164, U.S. Pat. No. 4,401,578, U.S. Pat. No. 3,974,076 or U.S. Pat. No. 4,237,016.

Desirably the fabric condition is a silicone based fabric softening agent. Typically the silicones to provide additional benefits such as ease of ironing and improved fabric feel. The preferred silicones are polydimethylsiloxanes of viscosity of from about 100 centistokes (cs) to about 100,000 cs, preferably from about 200 cs to about 60,000 cs. These silicones can be used as is, or can be conveniently added to the softener compositions in a preemulsified form which is obtainable directly from the suppliers. Examples of these preemulsified silicones are 60% emulsion of polydimethylsiloxane (350 cs) sold by Dow Corning Corporation under the trade name DOW CORNING (RTM) 1157 Fluid and 50% emulsion of polydimethylsiloxane (10,000 cs) sold by General Electric Company under the trade name General Electric (RTM) SM 2140 Silicones. The optional silicone component can be used in an amount of from about 0.1% to about 6% by weight of the composition. Typiccally the fabric conditioner is a silicone softening agent sold under the trade name Ciba Tinotex FSA (RTM) sold by Ciba Specialty Chemicals.

The polymeric particles according to the present invention can be conveniently produced for instance by the following steps,

A) providing an aqueous phase of a polymeric salt formed from a monomer blend which comprises said hydrophobic monomer and said free base monomer, which polymeric salt comprises a volatile counterion component,

B) dissolving or dispersing the fabric conditioner into the aqueous phase,

C) forming a dispersion consisting essentially of the aqueous phase in a water immiscible liquid phase which comprises an amphipathic polymeric stabiliser to form an emulsion, and

D) subjecting the dispersion to dehydration wherein water is evaporated from the aqueous particles thereby forming solid particles comprising the fabric conditioner distributed throughout the matrix polymer, wherein volatile counterion component of the salt is evaporated during the distillation and the matrix polymer is converted to its free base form.

Desirably the process also employs a polymeric amphipathic stabiliser in the water immiscible liquid. The amphipathic stabiliser may be any suitable commercially available amphipathic stabiliser, for instance HYPERMER (RTM) (available from ICI). Suitable stabilisers also include the stabilisers described in WO-A-97/24179. Although it is possible to include other stabilising materials in addition to the amphipathic stabiliser, such as surfactants, it is generally preferred that the sole stabilising material is the amphipathic stabiliser.

In the process of the present invention the dehydration step can be achieved by any convenient means. Desirably dehydration can be effected by subjecting the dispersion in oil to vacuum distillation. Generally this will require elevated temperatures, for instance temperatures of 30° C. or higher. Although it may be possible to use much higher temperatures e.g. 80 to 90° C. it is generally preferred to use temperatures of below 60 or 70° C.

Instead of vacuum distillation it may be desirable to effect dehydration by spray drying. Suitably this can be achieved by the spray drying process described in WO-A-97/34945.

The dehydration step removes water from the aqueous solution of matrix polymer and also the volatile counterion component, resulting in a dry polymer matrix which is insoluble an non-swellable in water, containing therein the fabric conditioner which is distributed throughout the polymeric matrix.

This process results in products which have enhanced effectiveness in that the polymer matrix which does not allow substantially any of the entrapped fabric conditioner to be released except under the desired rinse cycle of the laundry operation.

A polymeric shell may be formed around the particles of core, for instance by a coacervation technique as described in EP-A-356,239 or WO-A-92/20771 or, preferably, by interfacial condensation as described in, for instance, WO-A-97/24179.

Preferably the particles have a shell (around the core) of a polyamide or other condensation polymer, preferably formed by interfacial condensation.

The polymeric products can be further enhanced by including a cross-linking step in the process. This can be achieved by including self cross-linking groups in the polymer, for instance monomer repeating units carrying a methylol functionality. Preferably though the cross-linking is achieved by including a cross-linking agent with the aqueous phase polymer. The cross-linking agent are generally compounds which react with functional groups on the polymer chain.

The cross-linking process desirably occurs during the dehydration step. Thus where a cross-linking agent is included, it will generally remain dormant until the dehydration is started.

Generally the matrix polymer may be prepared by any suitable polymerisation process. For instance the polymer can be conveniently prepared by aqueous emulsion polymerisation for instance as described in EP-A-697423 or U.S. Pat No. 5,070,136. The polymer can then be neutralised by the addition of an aqueous solution of ammonium hydroxide or a volatile amine.

In a typical polymerisation process the blend of hydrophobic monomer and anionic monomer is emulsified into an aqueous phase which contains a suitable amount of emulsifying agent. Typically the emulsifying agent may be any commercially available emulsifying agents suitable for forming aqueous emulsion. Desirably these emulsifying agents will tend to be more soluble in the aqueous phase than in the monomer water immiscible phase and thus will tend to exhibit a high hydrophilic lipophilic balance (HLB). Emulsification of the monomer may be effected by known emulsification techniques, including subjecting the monomer/aqueous phase to vigorous stirring or shearing or alternatively passing the monomer/aqueous phase through a screen or mesh. Polymerisation may then be effected by use if suitable initiator systems, for instance UV initiator or thermal initiator. A suitable techniques of initiating the polymerisation would be to elevate the temperature of the aqueous emulsion of monomer to above 70 or 80° C. and then add between 50 and 1000 ppm ammonium persulphate by weight of monomer.

Generally the matrix polymer has a molecular weight of up to 200,000 (Determined by GPC using the industry standard parameters). Preferably the polymer has a molecular weight of below 50,000, for instance 2,000 to 20,000. Usually the optimum molecular weight for the matrix polymer is around 8,000 to 12,000.

Typically the monomer blend may contain at least 50% by weight hydrophobic monomer, the remainder being made up of anionic monomer. Generally though the hydrophobic monomer will be present in amounts of at least 60% by weight.

The particles that are formed can, depending upon the dispersion conditions and components, be in the form of beads which can be recovered as dry powder, for instance wherein the beads have a dry size of at least 90% by weight above 50 microns and often above 100 microns, for instance up to 1000 microns.

The particles according to the present invention generally have an average particle size diameter of less than about 100 microns. Generally the average particle size diameter tends to be smaller, for instance less than 70 or 80 microns, often less than 40 or 50 microns and typically the average particle diameter will be between 750 nanometers and 40 microns. More preferably the particles are 90% by weight below 30 microns. Preferably, however, the particles have a smaller size, generally 90% by weight below 30 microns and often below 10 microns or 20 microns down to, for instance, 0.5 microns or less. Average particle size is determined by a Coulter particle size analyser according to standard procedures well documented in the literature. It is then generally preferred that the particles remain as a substantially stable dispersion in a non-aqueous liquid. This tends to provide maximum stability when dispersed in liquids, for instance the detergent concentrate or the wash or rinse water of the laundry operation. Further more particles of this size tend to give optimal release properties during the rinse cycle.

Thus, either the particles do not settle out (which is preferred) or any settled particles can easily be redispersed by stirring or shaking.

The fabric conditioner containing the particles may be aqueous, typically containing up to 70% water and 0-30% organic solvent, or non-aqueous. Preferably, however, the composition should contain more matrix polymer to fabric conditioning active. Thus a particularly preferred composition comprises polymer to fabric conditioner in an amount of greater than 3:1. The ratio of polymer to fabric conditioner may be as a high as 20:1 or higher, but usually would not exceed 10 or 15:1. An especially suitable ratio is around 5:1 polymer to fabric conditioner.

The particles may be dispersed in a liquid detergent, for instance by blending a dispersion of particles (usually after dehydration) in a surfactant or in another water-immiscible liquid or in a water-immiscible liquid into the liquid detergent. Alternatively the particles may be distributed throughout solid detergent tablets. Thus in one preferred aspect of the invention we provide a detergent composition, which may be for instance in the form of a liquid detergent concentrate or a detergent tablet in which the particles are dispersed or distributed throughout the detergent composition and in which fabric conditioner is not released in the detergent composition or during the wash cycle of a laundry operation but is released during the rinse cycle of said laundry operation.

Typically the detergent composition comprises one or more surfactants, each of which may be anionic, non-ionic, cationic, or zwitterionic. The detergent will usually contain 0-50% of anionic surfactant such as linear alkylbenzenesulfonate (LAS), alpha-olefinsulfonate (AOS), alkyl sulfate (fatty alcohol sulfate) (AS), alcohol ethoxysulfate (AEOS or AES), secondary alkanesulfonates (SAS), alpha-sulfo fatty acid methyl esters, alkyl- or alkenylsuccinic acid, or soap. It may also contain 0-40% of non-ionic surfactant such as alcohol ethoxylate (AEO or AE), carboxylated alcohol ethoxylates, nonylphenol ethoxylate, alkylpolyglycoside, alkyldimethylamine oxide, ethoxylated fatty acid monoethanolamide, fatty acid monoethanolamide, or polyhydroxy alkyl fatty acid amide (e.g. as described in WO-A-92/06154).

The detergent, if built, may contain 1-65% of a detergent builder or complexing agent such as zeolite, diphosphate, triphosphate, phosphonate, citrate, nitrilotriacetic acid (NTA), ethylenediaminetetraacetic acid (EDTA), diethylenetriaminepentaacetic acid (DTMPA), alkyl- or alkenylsuccinic acid, soluble silicates or layered silicates (e.g. SKS-6 from Hoechst). The detergent may also be unbuilt, i.e. essentially free of detergent builder.

The detergent may comprise one or more polymers. Examples are carboxymethylcellulose (CMC), poly(vinylpyrrolidone) (PVP), polyethyleneglycol (PEG), poly(vinyl alcohol) (PVA), polycarboxylates such as polyacrylates, maleic/acrylic acid copolymers and lauryl methacrylate/acrylic acid copolymers.

The detergent may contain a bleaching system which may comprise a H₂O₂ source such as perborate or per carbonate which may be combined with a peracid-forming bleach activator such as tetraacetylethylenediamine (TAED) or nonanoyloxybenzenesulfonate (NOBS). Alternatively, the bleaching system may comprise peroxyacids of, e.g., the amide, imide, or sulfone type.

The detergent composition may be stabilized using conventional stabilizing agents, e.g. a polyol such as propylene glycol or glycerol, a sugar or sugar alcohol, lactic acid, boric acid, or a boric acid derivative such as, e.g., an aromatic borate ester, and the composition may be formulated as described in, e.g., WO-A-92/19709 and WO-A-92/19708.

The detergent may also contain other conventional detergent ingredients dyes, bactericides, optical brighteners, or perfume.

The following examples illustrate the invention.

### EXAMPLE 1

Preparation of Matrix Polymer A

A copolymer of about 65 weight % methyl methacrylate and 35 weight % tertiary butyl amino ethyl methacrylate is syntheisised thermally by solution polymerisation in an ethanol water mixture (about 35% ethanol) using tertiary butyl perbenzoate as initiator to provide a polymer of molecular weight 25 to 30,000. Water containing acetic acid was added and the alcohol solvent removed by vacuum distillation and the resulting co-polymer formed as the acetate salt, in water at pH 4 to 5.5.

### EXAMPLE 2

Preparation of Matrix Polymer B

Example 1 was repeated except that the ethanol was replaced by butyl acetate.

### EXAMPLE 3

Polymers C, D and E were prepared by the process according to example 1, wherein polymers are made from methyl methacrylate (MMA) and tertiary butyl aminoethyl methacrylate (tBAEMA) in the following weight % ratios as shown in table 1

TABLE 1

| POLYMER | MMA | tBAEMA |
|---|---|---|
| C | 85 | 15 |
| D | 70 | 30 |
| E | 55 | 45 |

Particles were prepared according to the process described in Example 4 using polymers C, D and E and varying amounts of a silicone fabric conditioner. The silicone included Ciba Tinotex FSA (RTM) aqueous emulsion of dimethyl siloxane oil or Dow Corning silicone fluid 200/1000 cS and varying amounts of amphipathic polymeric stabiliser as shown in table 2.

In each case 0.5 g of the dried particles thus formed from the process were added to 10 g of buffered water at pH 4, 9 and 10. The solutions were shaken well and then left to stir for one day. The solutions were observed at regular intervals for signs of silicon release. The results are shown in table 2

TABLE 2

| | | Silicone oil | Amount of | | | |
|---|---|---|---|---|---|---|
| | | (weight ratio | stabiliser | Release profile | | |
| Test | Polymer | polymer to oil) | (weight %) | at pH 4 | at pH 9 | at pH 10 |
| 1 | C | none | 0.5 | swelling - no | swelling - no | swelling - no |
| | | | | dissolution | dissolution | dissolution |
| 2 | C | 3:1 (Ciba) | 0.5 | very slow | no release | no release |
| | | | | release over | | |
| | | | | days | | |
| 3 | C | 4.2:1 (Dow) | N/A | no release | no release | no release |
| 4 | D | none | 0.5 | swelling - no | swelling - no | swelling - no |
| | | | | dissolution | dissolution | dissolution |
| 5 | D | 3:1 (Ciba) | 0.5 | slow release | slow release | no release |
| | | | | but more | | |
| | | | | than at pH 9 | | |
| 6 | E | none | 0.5 | swelling - no | swelling - no | swelling - no |
| | | | | dissolution | dissolution | dissolution |
| 7 | E | 2:1 (Ciba) | 0.5 | full release | some | No release |
| | | | | within | release | |
| | | | | seconds | within | |
| | | | | | seconds | |

The above results show that the release rate of the silicone fabric conditioner can be controlled according to the proportion of free base monomer present. Thus a fast release in the rinse cycle would be brought about by a higher amount of free base monomer.

### EXAMPLE 4

Preparation of Cationic Fabric Conditioner Dispersion

The cationic surfactant dispersion was made by pouring melted monostearyl trimethyl ammonium chloride (at about 60° C.) into hot water containing polyvinylpyrrolidone stabiliser (1%) and ammonium sulphate (7.5%). The mixture was allowed to cool with stirring being maintained until mixture reached room temperature.

### EXAMPLE 5

Preparation of Cationic Base Conditioner Entrapped Particles

A aqueous phase was made by combining the fabric conditioner made by example 3 to the solution of matrix polymer A. An oil phase was prepared by mixing an isoparaffinic solvent (Isopar G) and an amphipathic polymeric stabiliser. A water in oil dispersion was made by mixing the phases with stirring. The dispersion was subsequently dehydrated by vacuum distillation keeping the temperature at below 50° C. Once no more water could be recovered, the beads were recovered by filtration and air dried. The beads were typically 100-200 microns and the product contained 25-30% active fabric conditioner.

Evaluation studies confirmed that when the particles were dispersed in a commercially available solid tablet detergent concentrate there was no release of the fabric conditioner.

Furthermore when the particle were mixed with a simulated wash water containing about 5% detergent concentrate the fabric conditioner was not released even after vigorous stirring.

Finally when the particle were mixed with a simulated rinse water containing less than 0.5% detergent concentrate, the fabric conditioner was virtually completely released.

### EXAMPLE 6

Example 5 was repeated except using the matrix polymer B. Evaluation studies confirmed analogous results to Example 5.

1. A particulate composition comprising particles having a polymeric matrix including a fabric conditioning active ingredient and wherein the polymeric matrix is formed of a co-polymer of (a) an ethylenically unsaturated hydrophobic monomer with (b) a free base monomer

2. A composition according to claim 1 in which the free base monomer has the formula
CH2═CR₁COXR₂NR₃R₄
where R₁ is hydrogen or methyl, R₂ is alkylene containing at least two carbon atoms, X is O or NH, R₃ is a hydrocarbon group and R₄ is hydrogen or a hydrocarbon group.

3. A composition according to claim 2 in which R₃ is at least 4 carbon atoms.

4. A composition according to claim 2 or claim 3 in which R₃ is t-butyl and R₄ is hydrogen.

5. A composition according to any of claims 2 to 4 in which R₁ is methyl, R₂ is ethylene and X is O.

6. A composition according to any of claims 1 to 5 in which the hydrophobic monomer is selected from the group consisting of monomers which are capable of forming a homopolymer of glass transition temperature in excess of 50° C.

7. A composition according to any of claims 1 to 6 in which the hydrophobic monomer is selected from the group consisting of styrene, methyl methacrylate, acrylonitrile, tertiary butyl methacrylate, phenyl methacrylate, cyclohexyl methacrylate and isobornyl methacrylate.

8. A composition according to any of claims 1 to 7 in which the polymer is a co-polymer of 55-85 weight % of methyl methacrylate with 15%-45% by weight tertiary butylamino-ethyl methacrylate.

9. A composition according to any of claims 1 to 8 in which the particles are 90% by weight below 30 microns.

10. A composition according to any of claims 1 to 9 in which the ratio of matrix polymer to fabric conditioning active ingredient is greater than 3:1.

11. A composition according to any of claims 1 to 10 and which is a dispersion of the particles in a detergent concentrate.

12. A composition according to claim 11 in which the detergent concentrate is a liquid detergent concentrate or a solid detergent tablet and wherein the fabric conditioner is not released in the concentrate or during the wash cycle of a laundry operation but is released during the rinse cycle of said laundry operation.
